(19) United States
(12) Patent Application Publication
(10) Pub. No.: US 2008/0065510 A1
(43) Pub. Date: Mar. 13, 2008

(54) Chart based real time investment monitoring, analyzing, and trading system

(76) Inventor: Dan Yu, Herndon, VA (US)

Correspondence Address: LATIMER, MAYBERRY & MATTHEWS IP LAW, LLP, 13873 PARK CENTER ROAD, SUITE 122, HERNDON, VA, 20171, US

(21) Appl. No.: 11/518,939

(22) Filed: Sep. 12, 2006

(51) Int. Cl. G06F 17/30

(52) U.S. Cl. 705/27

(57) ABSTRACT

A chart based investment monitoring, analyzing and trading system for real time security trading is provided. The system uses computers or other computing devices, investment historical data, and real time market data to create dynamic investment charts. These charts are used in a highly integrated platform for investment monitoring, trading, analyzing, and data searching. The market information like quotes, option and future quotes, the news, and etc. can be easily found on the charts; the chart is a search and study platform also. Historical data of any day can be easily found out on the charts if exist; the charts are the trading platform as well. A trade can be placed right away from the charts. It also provides powerful tools for changing the parameters or settings of multi-charts at the same time with one click; it allows the investors dynamically view and find out the right parameters of the technical indicators. It provides unlimited investments monitoring.

### BACKGROUND OF THE INVENTION

1. Field of the Invention

The present invention relates to the field of investment monitoring, analyzing, and trading. More specifically, the present invention relates to a computer system for real-time investment monitoring, analyzing, and trading in the financial sector of the world economy. The system of the invention finds use in real-time investment monitoring, analyzing, and trading for professional investors, traders, and general investors as well.

2. Description of Related Art

Technical analysis, which is also sometimes referred to as market analysis, is the oldest investment analysis method in the world. It is one of the most popular investment analysis method used in the investment world today. It attempts to use past investment price and volume information to predict future price movements. It also attempts to time the markets. It concerns itself with price, volume of transactions, and individual/group psychology.

One of the many attractions of the technical analysis approach is that its methodology can be applied almost identically in any market anywhere. The approach works as well in the United States as in China as in Europe, and in developed or developing markets. The same techniques can be applied to, but not limited to, stocks, currencies, commodities, mutual funds, bonds, interest rates, equities, and etc.

For technical analysts, charts are considered one of the best tools to have at their disposal. For the purpose of monitoring and analyzing investments and designing trading strategies, charts enable investors and analysts to plot investment prices, volumes, and other indicators on a graph, which is commonly referred to as an investment chart. As used herein, an investment chart includes a Line Chart, a Bar Chart, a Candle Bar Chart, and the like. Most people in the field find these investment charts very useful. In essence, technical analysis is all about constructing investment charts and analyzing them to draw conclusions about an investment: when to buy and when to sell. With the help of a computer, constructing investment charts is relatively easy now.

In today's investment world, not only those investors who believe in the value of technical analysis rely on investment charts. Other investors also use it to help make investment decisions. However, since graphically depicting charts consumes a large amount of space on a screen, it is not suitable for monitoring the movement of many investments at the same time. Instead, tables or some similar methods are used for that purpose.

Others have developed systems to improve methods of using tables for monitoring and trading. For Example, U.S. Patent Application Publication No. 20030009411 to Ram et al. discloses an interactive grid-based graphical trading system for use in securities trading. This system provides a dynamic, visual display of trading data consisting of orders, quotes, and indices, for any security and for any number of market participants. The trading data are plotted on a grid consisting of cells arranged in rows and columns, which are associated with specific parameters. Distinct visual presentation styles are used, and differences in the price parameter are represented spatially. The values of the price and other parameters associated with the same orders and quotes are mapped against the values associated with the rows and columns of the grid. A trader may place or modify trading orders by interacting with the trading data displayed on the grid, and with specific Graphic User Interface (GUI) objects displayed on the same grid.

However, shortcomings still remain. Both the table and the grid approaches only provide limited information about an investment like the price of open, high, low, close, volume and etc. An investor would have no idea about the movement status of an investment by simply reading these numbers. He has to read the investment charts frequently before make his investment decisions. This not only is tedious but also significantly limits an investor's capability to monitor and analyze many investments at the same time and quickly make sound investment decisions in real-time.

Investors using technical analysis to make investment decisions usually read two kinds of charts. One is the daily investment chart, which uses bars to describe the market movement. Each bar represents the market movement of a day with open, close, high, and low price. Another is the intraday or multi-day intraday investment chart, which uses bars or lines to describe the market movement tick by tick in great details. The daily investment chart is used for predicting longer trends of the market while the intraday investment chart is used for predicting the market's movement in a very short period. Many experienced investors find that combining the analysis of these two kinds of charts will turn out greater accuracy for timing the market. However, they have to open two windows separately with existing investment, monitoring, analyzing, and trading system (used interchangeably herein with “existing systems”). That is very inconvenient.

Investment charts are very important for monitoring and analyzing investments. The price quotes, option or future quotes, news, and other information of an investment are equally important for an investor to make wise investment decisions. However unfortunately, investors have to look the information in different places with existing systems. This drawback significantly limits an investor's ability to quickly react to the fast changing market. It is desirable to integrate them into one investment chart or on to one screen.

Technical indicators are other useful tools for investment technical analysts. Finding the right parameters for these indicators is very important for making the right investment decisions. For example, moving averages (MA) are the most important technical indicators for finding the resistant or support points of any investment. Investors find that 50 days MA and 200 days MA work for some of the investments while 30 days MA or 23 days MA work for other investments. However, it is very inconvenient to find the right parameters with existing systems.

Experienced investors know that the markets are related. When the investor loses direction in one market, he might find a clue by analyzing another. Monitoring and studying related investments or markets are very important for making right investment decisions. It is desirable to have global controls to dynamically change the views and the settings of multiple investment charts at the same time with single click. Existing investment tools provide none of these functions.

Investment charts used today are merely served as the graphic interfaces for describing the movement status of an investment. However, it is desirable to use them as platforms for searching and analyzing the historical data of the investment as well so investors can find any information associated with the investment from the charts directly.

Human beings are good at graphic recognition. Graphs can help people make quicker and better decisions. So, it is desirable to place orders and set warnings, conditions, and triggers on the charts visually. Unfortunately, these kinds of systems cannot be found in today's investment world.

### SUMMARY OF THE INVENTION

The present invention addresses needs in the art by providing a computer program, a method, and a system that turns investment charts to an integrated information center for real-time investment monitoring, analyzing, and trading. It further makes the investment charts suitable for unlimited investment monitoring in real time. The integrated information may include, but is not limited to, the option quotes, future quotes, news and quotes for any investment. It further integrates one daily investment charts and one or more intraday investment charts into one completely new investment chart (call investment chart below) for each of the investments so that the users can have a full image of the market movement at one place at one glance. The users don't have to switch back and forth from one chart to another. It makes the monitoring easier and more convenient, and helps the users make decisions faster and wiser. It further integrates trade functions into an investment chart. Users can place orders and conduct other trade operations directly on the investment chart while continuing to monitor the changing markets. They don't have to leave the investment charts and do the trade operation at other places like they do it using existing systems. It also makes an investment chart an information search center. The users can easily find out any historical information of a day by choosing the data displaying mode and clicking a bar on the investment chart that represents that day. Any historical information of any date can be found and displayed as long as the data exist. In addition, the present invention provides a method and system and software to allow users to visually place their orders, and set warnings, conditions, and triggers on investment charts directly. This system will greatly help the users to make sound investment judgments and decisions and finish the operation easily.

In general, the present invention relates to an investment monitoring, analyzing and trading system. More particularly, the present invention relates to a method and system that gives the users ability to monitor, analyze and trade unlimited investments world wide in real time. It further provides the users highly integrated investment charts that make it possible to get any investment activities done easily on the investment charts. It further turns the investment the convenient information center. It further gives the users the ability to manipulate multiple investments simultaneously. It also provides capability gathering real time investment data from any online sources like the computer server(s) of online brokers and etc.

Broadly speaking, an investment chart-based monitoring, analyzing and trading system is provided. The system uses computer(s) or other computing device(s), real historical data, real time data, and a computer program to generate highly integrated investment charts to help the users get their investment activities done on the investment charts. The system provides powerful monitoring tool to allow users to monitor unlimited investments at the same time. The system turns the investment chart to an information center. The users can easily find out any historical information of a day by choosing the data displaying mode and executing (e.g., clicking) a bar on the investment chart that represents that day. Any historical information of any date can be found and displayed as long as the data exist. It gives the users the convenience to control multiple charts with one click.

In a first aspect, the invention provides a method of turning an investment chart into an information center. In general, the method integrates investment information, monitoring functions, analyzing functions, trading function and etc. into investment charts. The method typically also gives the users the ability to monitor unlimited investments simultaneously world wide. The method provides global control to the users for multiple investment charts manipulation. The method provides the ability to collect data from multiple online sources.

In a second aspect, the invention provides a computer program. The methods mentioned herein are coded into the program. The program runs on the computer(s) and other computing device(s) combine with others like internet connection, system configuration and etc. to form the system. The program may be in any programming language, and is, at its basic level, represented by programming code.

In another aspect, the invention provides a storage medium comprising the computer program and/or method. The storage medium may be any medium that is suitable for storage of a computer program, including, but not limited to, a computer disk, such as a floppy disk, an optical computer disk, such as a compact disk (CD) or a digital virtual disk (DVD), a memory stick or flash drive, a hard disk, and random access memory (RAM). The storage medium is suitable for use in a computer or computer network, and may be removable and portable or may be an integral, non-portable part of a computer or computer network.

In another aspect, the invention provides a computer or computer network comprising the program or method of the invention. The computer may be any type of computer, including, but not limited to, a personal computer, a network server, and a hand-held computing or communication device. The program may be present on the computer in a stable, long-term form, such as in the form of a program stored on a storage medium. Alternatively, the program may be present on the computer in an ephemeral form, such as in RAM. The computer or computer network may, of course, comprise only a portion of the program, for instance data files relevant to the user's actions (e.g., investments, performance, data relative only to particular investments, value of portfolio, etc.).

In yet a further aspect, the invention provides a system for monitoring, analyzing and trading one or more markets or sub-markets. In general, the system comprises hardware and software, and the hardware is capable of running the software. In embodiments, the system comprises hardware, software, one or more databases, one or more network connections, and optionally other components. The system may comprise a single computer running the software, or multiple computers, each running a copy of the software or some or all sharing the software. The system thus may be a personal computer or a network of computers, such as the Internet or an intranet.

In yet a further aspect, the invention provides a method of doing business using a computer or computer system. The method comprises providing a computer program according to the invention on a computer connected to the Internet, and charging a fee for use of the program. The fee may be charged for use of the program over the Internet (i.e., for access to a website running the program). Alternatively, the fee may be charged for downloading of the computer program from a website on the Internet. Yet again, the fee may be charged for purchase of a portable storage medium comprising the computer program (e.g., a CD to be shipped to the purchaser).

It is further an aspect of the present invention to provides global functions to dynamically change the views and settings of multi-charts at the same time with one click so that users can easily compare and analyze multi-investments or multi-markets to find out their relationship.

In yet a further aspect, the invention provides methods to allow users to dynamically and continually change the parameters of the technical indicators of an investment. Users can easily find out these parameters which are hard to find with existing systems.

### BRIEF DESCRIPTION OF THE DRAWINGS

The accompanying drawings, which are incorporated in and constitute a part of this specification, illustrate several embodiments of the invention and together with the written description, serve to explain certain principles of the invention. Other principles and details of the invention may be found in the written description or be evident from the drawings, written description, claims, and general knowledge held by those of skill in the art.

FIG. 1 is a diagram showing the main menu of the monitoring, analyzing, and trading system of one embodiment of the present invention. Included is a sub-menu for Trade.

FIG. 2 is a screen shot that demonstrates how to setup the monitoring screens by using the system of present invention.

FIG. 3 is a screen shot of a monitoring screen with a normal configuration.

FIG. 4 is a screen shot of an investment chart according to embodiments of the invention.

FIG. 5 is a screen shot of the control panel for unlimited investments monitoring.

FIG. 6 is a screen shot of the global control panel.

FIG. 7 demonstrates some of the modes of an investment chart based information method and system.

FIG. 8 demonstrates how to visually find the appropriate parameters of the technical indicators such as moving average and etc.

FIG. 9 demonstrates how to open orders, set warnings, conditions, and triggers in the system of the present invention.

FIG. 10 is a flow chart that demonstrates the working mechanism of the multi-source real-time data collection system.

FIG. 11 is a piece of pseudo code that demonstrates the logic of the unlimited investments monitoring system.

FIG. 12 is a piece of pseudo code that demonstrates the logic of the global control system.

### DETAILED DESCRIPTION OF VARIOUS EMBODIMENTS OF THE INVENTION

Turning now to the Figures, various features of embodiments of the invention will be described in detail. Those of skill in the art will understand that various other features may be provided within the context of the invention without departing from the spirit of the invention.

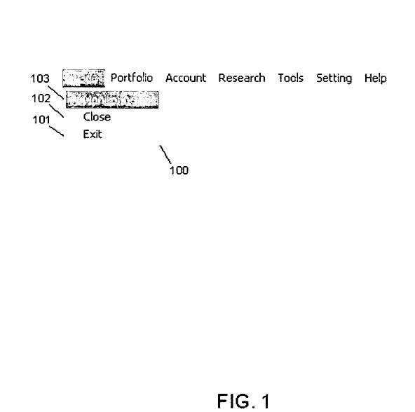

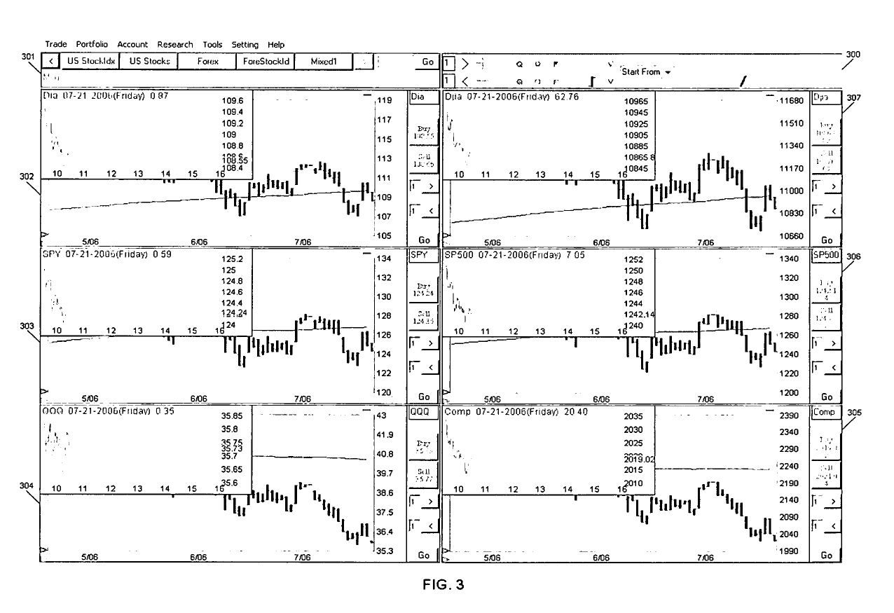

The main menu shown on FIG. 1 is the first screen displayed after logging in the investment chart based monitoring and trading system of the present invention. A sub-menu 100 will pop up when clicking Trade on the main menu. There are three items in the sub-menu 100. Item Exit 101, when clicked, enables an investor to exit the system; item Close 102 enables a user to close everything displayed on the screen except the main menu; if item Monitoring 103 is clicked, the first monitoring screen will show up illustrated on FIG. 3.

Before discussing the monitoring screen, it is important to discuss how the system of the present invention solves the multi-investments monitoring. Investment charts work well to help users to make quick and correct investment decisions. However, since these consume too much space, they are not suitable for monitoring many investments in real-time. A user is thus left with the problem of how to break this dilemma. The system of the present invention successfully solves it by using an Unlimited Investments Monitoring Method and provides an Unlimited Investments Monitoring System. The Unlimited Investments Monitoring Method may comprise the steps of: dividing and grouping multi-investments to be monitored into one or more computer screens, wherein each screen can display a limited number investment charts, but the number of screens is unlimited; presenting one or more screens, each of which holds at least one investment chart for each investment being monitored; providing a method for quickly switching between screens; and providing a search method to locate a screen by using the following criteria, including, but not limited to, screen name, screen ID, investment symbol(s) defined for the screen and then quickly display the screen searched. The Unlimited Investments Monitoring System can: 1) allow a user to divide and group multi-investments into one or more computer screens, wherein each screen can display a limited number investment charts, but the number of screens is unlimited; 2) present one or more screens which hold at least one investment chart for each investment being monitored; 3) provide a system for quickly switching between screens; and 4) provide a search system to locate a screen by using the following criteria, including, but not limited to, screen name, screen ID, investment symbol(s) defined for the screen and then quickly display the screen searched.

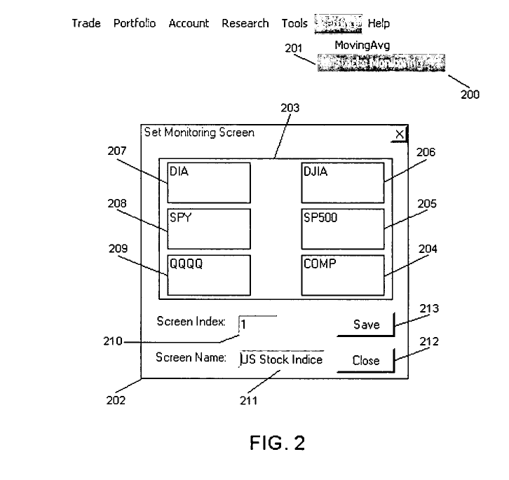

FIG. 2 is a screen shot that demonstrates how to setup the monitoring screens by using the system of the present invention. A sub-menu 200 will pop up when clicking Setting on the main menu. There are two items on the sub-menu 200. If item Stocks Monitoring 201 is clicked, the Set Monitoring Screen form 202 will pup up. The system of the present invention can simultaneously monitor unlimited investments of any market world wide for which price movement can be represented by investment charts, such as stocks, foreign exchanges, commodities, mutual funds, bonds and etc. The system of the present invention uses screen index number and a screen name to represent a screen. The screen index number can be entered into to Screen Index field 210 and a screen name can be entered into Screen Name field 211. Area 203 is the screen layout. It should be decided how many and which investments should be on this screen and how to arrange them. The screen layout can be simply decided by entering investment symbols into the text fields 204, 205, 206, 207, 208 and 209. The investment charts will be displayed in the order as text fields 204, 205, 206, 207, 208 and 209 indicate. Once that is done, the user can click the Save button 213 to save the definition. If more investments need to be monitored, the above steps can be repeated to define more screens for those investments. Once the settings of the monitored screens have been set, click button Close 212 to close the Set Monitoring Screen. FIG. 2. shows an example to define a screen with screen name US StockIdx, screen index 1 and with 6 investments.

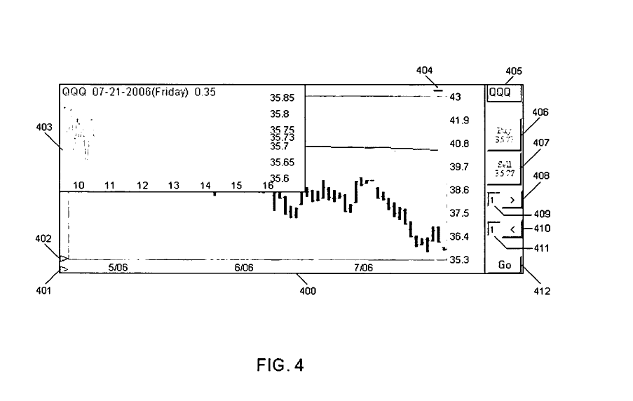

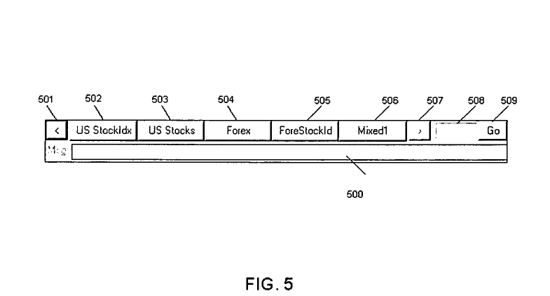

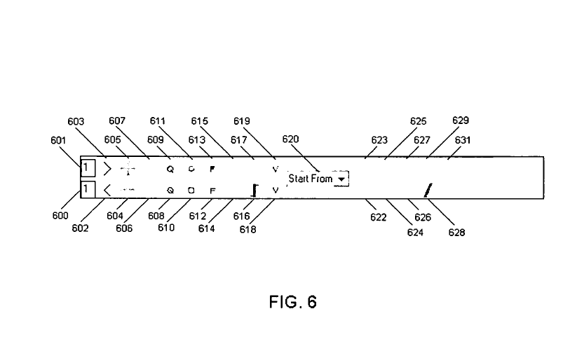

FIG. 3 is the screen shot of a monitoring screen with a normal configuration. A normal configuration monitoring screen includes a control panel 301 for unlimited investments monitoring, a global control panel 300 for synchronously changing the views or settings of all of the investment charts on current screen, and 6 investment charts 302, 303, 304, 305, 306 and 307 which are predefined in FIG. 2 as an example. Since all of the functions of the investment charts are the same, investment chart 305 will be used for explaining these functions with reference to FIG. 4. Control panel 301 will be described below with reference to FIG. 5; Global control panel 300 will be discussed below with reference to FIG. 6.

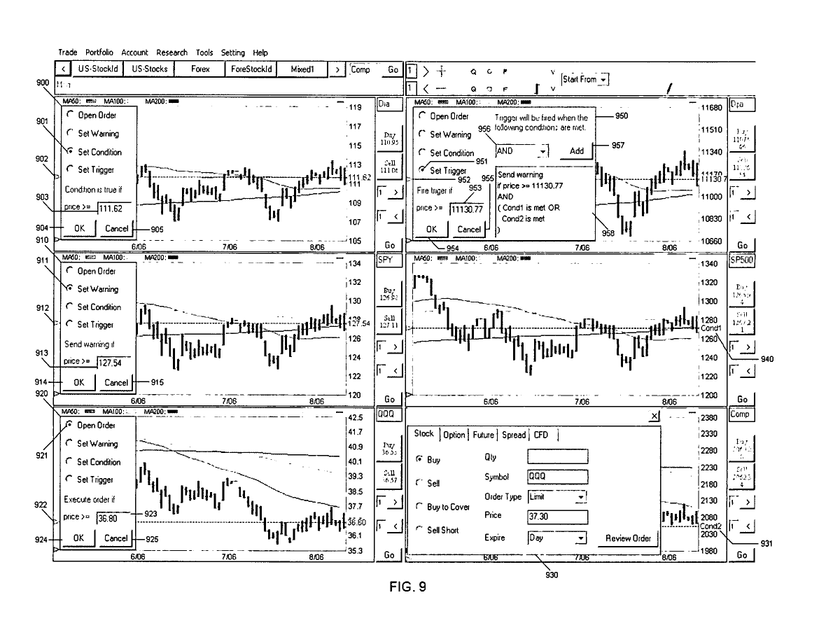

FIG. 4 is a screen shot of an investment chart according to embodiments of the invention. The investment chart of the present invention is a daily investment chart with intraday investment chart and other highly integrated functions or systems that enable a user to get any trade activity done inside the investment chart. The trade activities may be investment monitoring, analyzing, planning, information recording, trading, and etc. For monitoring, normally there is an intraday investment chart 403 inside the daily investment chart 400. This will give a user a whole picture of the movement status of the monitored investment. The intraday investment chart 403 can be hidden or unhidden, enlarged. It can be line style or bar style or candle bar style, or other style. It can display multi-days as a multi-days intraday chart. There are two triangles located at the lower left side of the chart. Triangle 402 is used to find the exact price of the investment at any point on the chart. Triangle 401 is used to open orders, set triggers, warnings, and conditions of triggers. It will be discussed in detail later with reference to FIG. 9. Both of the triangles 401 and 402 can only be moved up and down inside the chart's boundary. Icon 404 is used to zoom out the daily investment chart. If icon 404 is clicked, more icons will appear next to it. These icons are used to zoom in, draw lines, arrow lines, text and etc. on this daily investment chart. Text field 405 is used to display the investment symbol and to change the investment symbol to be displayed on this investment chart. If a different investment symbol is entered into this field and Enter key pressed or Go button 412 is clicked, investment chart 400 will change to represent the new investment. Buttons 406 and 407 are used to display the bid price and ask price respectively. If any of them is clicked, a trade order form will pop up for placing trade orders. The < button 410 is used to shift the bars displayed on the daily investment chart to left and > button 408 is used to shift to right respectively. There are three shift modes, mode 1, mode F and E. If 1 is entered into text field 409 and button 408 is clicked, the bars would shift one bar toward right side; If F is entered into text field 409 and button 408 is clicked, all bars on the current chart will shift one screen toward the right, and all bars on the current chart would move out toward the right side; If E is entered into text field 409 and button 408 is clicked, the bars would shift to the earliest date available; If 1 is entered into text field 411 and button 410 is clicked, the bars would shift one bar toward left side; If F is entered into text field 411 and button 410 is clicked, all bars on the current chart will shift one screen toward the left, and all bars on the current chart would move out toward the left side; If E is entered into text field 411 and button 410 is clicked, the bars would shift to the latest date available. The shift modes 1, F and E can be selected by simply double click on text filed 409 and 411. If the current shift mode is 1 on text filed 409 or 411, shift mode F will be selected by double click one time, shift mode E will be chosen by double click another time, shift mode 1 will be selected again by double clicking three times and so on so forth. Except for using double click to change shift mode, a select list or other methods can achieve the same goal.

FIG. 5 is a screen shot of the control panel for unlimited investments monitoring. Button 502, 503, 504, 505 and 506 are screen examples that can be predefined in Set Monitoring Screen with reference to FIG. 2. The order of these screens is decided by the screen index which is set there as well. The current example shows US StockIdx 502 is highlighted, so the monitoring screen of FIG. 3 displays the 6 US stock indexes defined on FIG. 2. If the user clicks on the Forex button 504, the foreign exchanges like EUR_USD, GBP_USD, USD_JPY and etc. will be displayed on the monitoring screen. The users can switch screens by clicking buttons 502, 503, 504, 505, and 506. If the screen name in not on current control panel but it has been pre-defined, the user can use the shift button 501 or 507 to bring it out; or if the user knows any investment symbol on a screen, say XYZ, he can simply type XYZ into text field 508 and click Go button 509 to locate it. The screen that has this symbol will display with in its pre-defined layout. The caption field 500 is used to display the investment symbols with warnings or coming news and etc.

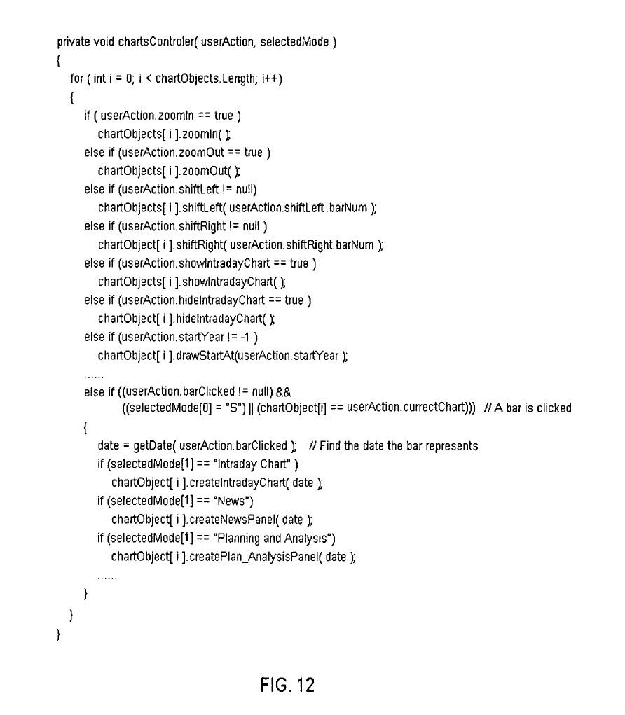

FIG. 6 is a screen shot of the global control panel. It is the interface of global control system. Text fields 601 and 600 are used for selecting shift modes. It can be used exactly in the same way as text fields 409 and 411 described on FIG. 4. The only differences are that text field 601 and 600 are used for selecting global shift mode of all investment charts on current screen while 409 and 411 are used for choosing the shift mode of single investment chart only. Icons from 602 to 619 are global function icons while icons from 622 to 631 are global mode switch icons. Combo box 620 is used to select the start date of all investment charts on current screen. Once a start date is selected from 620, all daily investment charts of the investment charts on current screen will change synchronously to the same start date indicated by 620. Icons 602 is used to shift the bars of all investment charts on current screens to the left at the same time based on the mode selected on 600 while 603 is used to shift the bars of all investment charts on current screens to the right at the same time based on the mode selected on 601. Their working mechanism and usages are the same as 408, 409, 410 and 411 explained above. Icon 605 is used to zoom in while icon 604 is used to zoom out all investment charts on a current screen with one click. Icons 607, 609, 611, 613, 615, and 619 are used to hide intraday charts, quote panels of the investments, option quote panels of the investments if they exist, future quote panels of the investments if they exist, news panels and volume charts located inside those investment charts respectively while Icons 606, 608, 610, 612, 614 and 618 are used to unhide the intraday charts, quote panels of the investments, option quote panels of the investments if they exist, future quote panels of the investments if they exist, news panels, and volume charts located inside the investment charts respectively. If icon 617 is clicked, all investment charts on current screen will be displayed with candle bar style; if icon 616 is clicked, they will be displayed with bar style. If icon 623, 625, 627, 631, 622, 624 or 626 is clicked, all investment charts on current screen will switch to “Intraday Chart Mode”, “Volume Mode”, “News Mode”, “Planning and Analyzing Mode”, “Trade Lesson Mode”, “Comments Mode”, or “Weekly Events Mode” respectively. If any bar on a chart is clicked, depending on which icon is selected, 623, 625, 627, 631, 622, 624 or 626, then the historical intraday chart, volume chart, news panel, planning and analyzing panel, trade lesson panel, comments panel, or weekly events panel associate with the date the bar indicated will show up respectively; icon 628 is asynchronous mode, if clicked, any operation on an investment chart will change that chart only; icon 629 is synchronous mode, if clicked, any operation on an investment chart will synchronously change all investment charts on the current screen accordingly. For example, after icons 629 and 623 are clicked, if the user clicks a bar on any one of the investment charts, then an intraday chart will pop up on each one of the investment charts on current screen. They are the historical intraday charts of the day indicated by the bar clicked. The system of the present invention provides another powerful zoom in function. If icon 629 is clicked, and any part of any one of the investment charts is highlighted, this will result in the highlighted portion to be zoomed in on that investment chart and the corresponding portion on other investment charts of current screen to be zoomed in at the same time. FIG. 12 is a piece of pseudo code that demonstrates the logic of the global control system.

Traditionally, investment charts are used to describe the market moving status only. It is observed that the bars on the investment chart are associated with dates or time periods. Therefore, the bar can be used as a key to search the database and find out any information associated with the date or time period the bar represents. The system of the present invention provides an investment chart based information search method and system that turns the investment chart to an information center for the investment the chart describes. The method can comprise one or more of the following steps, in any order: providing a database, wherein the database comprises real historical information for a plurality of investments; providing information modes such as intraday chart mode, volume chart mode, news mode, weekly events mode, trade lessons mode, planning & analyzing mode, comments mode and etc. for a user to choose, wherein the information mode chosen will decide the information to be displayed; enabling the bars on the investment chart to be clickable; invoking an event or function to search the information associated with the date or time period represented by the bar clicked; presenting the information found to the user either inside or outside the investment chart. However, if information related to the selected mode for the selected date doesn't exist, this will invoke functions to allow user to add the information

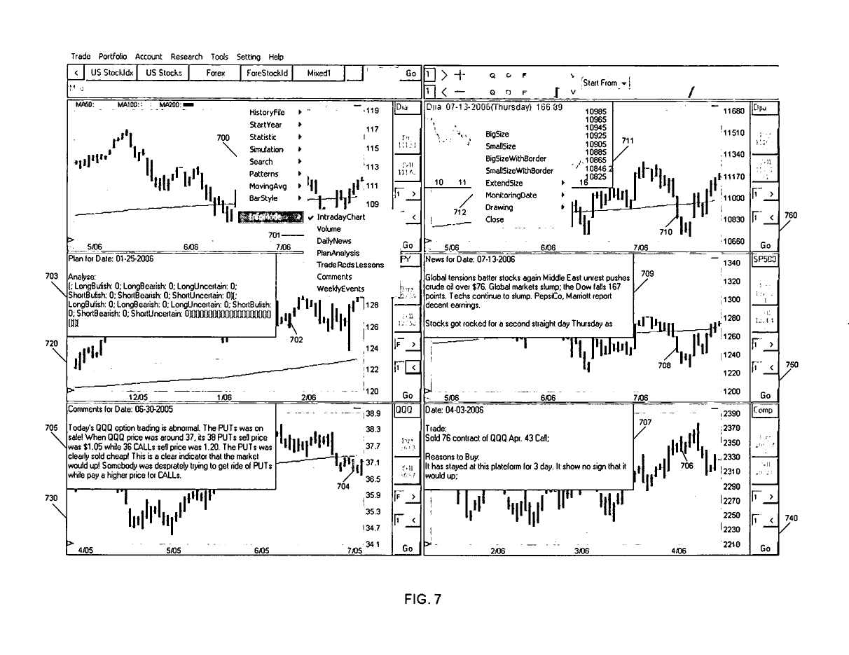

FIG. 7 demonstrates some of the modes of an investment chart based information method and system. Each investment chart of the present invention is an independent platform. It provides identical functions and services to the investment it presents. If moving the cursor into any investment chart and clicking the right button of the mouse, a menu 700 will pop up. If item “InfoMode” on menu 700 is clicked, a sub-menu 701 will show up. Sub-menu 701 is the place where the information mode can be set for the chart selected. The information mode on the Sub-menu 701 includes, but is not limited to, IntradayChart mode, Volume mode, DailyNews mode, WeeklyEvents mode, TradeRcdsLessons mode, PlanAnalysis mode, Comments mode and etc. Chart 720 shows an example when “PlanAnalysis” mode is set for that chart. Once “PlanAnalysis is selected, some or all of the bars on chart 720 will change to a different color to indicate that there are historical plan and analysis records for those days the bars represent. If bar 702 is clicked, a text box 703 with the plan and analysis of date Jan. 25, 2006 will pop up. If bar 702 represents the latest date, an empty text box with all functions that allow the user to finish his analyzing and planning for the next day will pop up; Chart 730 shows an example when “Comments” mode is set for that chart. Once “Comments” is selected, some or all of the bars on chart 730 will change to a different color to indicate that there are historical comment records on the dates the bars represent. If bar 704 is clicked, a text box 705 with the comments of date Jun. 30, 2005 will pop up. If there are no comments for Jun. 30, 2005 which bar 704 represents, an empty text box with all functions that allow the user to finish his comments will pop up; Chart 740 shows an example when “TradeRcdsLessons” mode is set for that chart. Once “TradeRcdsLessons” is selected, some or all of the bars on chart 740 will change to a different color to indicate that there are historical records of trade records and lessons on the dates the bars represent. If bar 706 is clicked, a text box 707 with the trade records and lessons of date Apr. 3, 2006 will pop up. If there is no trade records and lessons for Apr. 3, 2006 which bar 706 represents, an empty text box with all functions that allow the user to document his trade records and lessons will pop up; Chart 750 shows an example when “DailyNews” mode is set for that chart. Once “DailyNews” is selected, some or all of the bars on chart 750 will change to a different color to indicate that there are historical news records on the dates the bars represent. If bar 708 is clicked, a text box 709 with the daily news of date Jul. 13, 2006 will pop up; Chart 760 shows an example when “IntradayChart” mode is set for that chart. Once “IntradayChart” is selected, some or all of the bars on chart 760 will change to a different color to indicate that there are historical intraday chart on the dates the bars represent. If bar 710 is clicked, an intraday chart 711 of date Jul. 13, 2006 will pop up. If moving the cursor into the intraday investment chart 711 and clicking right button of the mouse, a menu 712 will pop up. If selecting item MonitoringDate from menu 712 and then set the days to view, intraday chart 711 can be turned into a multi-days intraday chart displaying the set days dating back from Jul. 13, 2006.

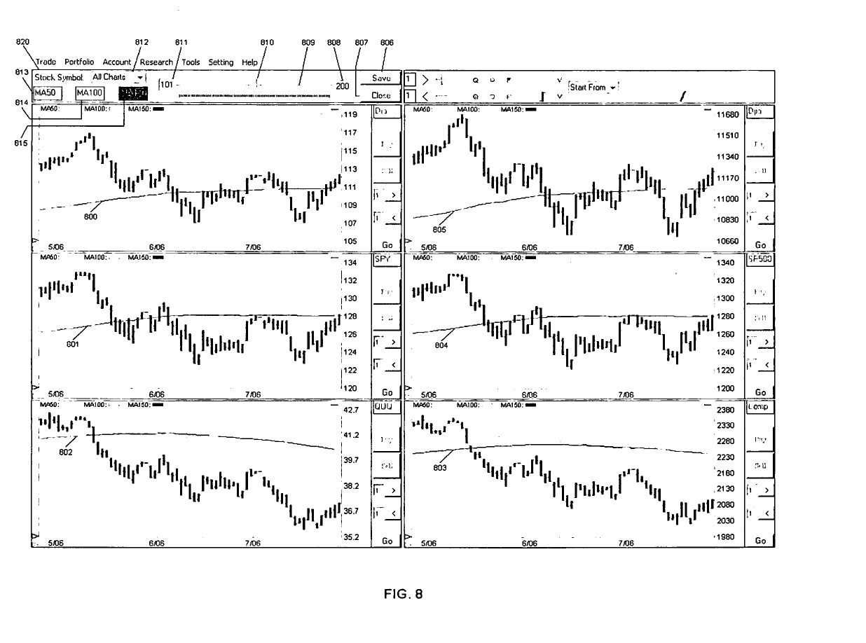

FIG. 8 demonstrates how to visually find the appropriate parameters of the technical indicators such as moving average and etc. for investment(s) by using a technical indicator parameter search system. If item MovingAvg on sub-menu 200 of FIG. 2 is clicked, panel 820 will pop up. It allows a user to easily set or find out the right moving average (MA) parameter(s) for the investment(s). A user can select an investment from combo box 812. If the selected investment is not on current screen, the system will automatically switch to the screen with the selected investment. The example in FIG. 8 shows that 3 moving average parameters for the investments are set. The value of MA50 in text box 813 indicates that there is a 50_day moving average, which is corresponding to the 50_day moving average line (MA 50) on the chart(s). The value of MA100 in text box 814 indicates that there is a 100_day moving average, which is corresponding to the 100_day moving average line (MA 100) on the chart(s). In the same way, the value of MA150 in text box 815 indicates that there is a 150_day moving average, which is corresponding to the 150_day moving average line (MA 150) on the chart(s). Each of the text boxes has a corresponding moving average line(s) associated with it. The color of the text box and the corresponding moving average line is the same, so which text box represents which moving average line can be easily identified. The user can change the color of the text box 813, 814, or 815 by double clicking on it. A color setting form will pop up to allow the user to change the color. Once the change is saved, the color of the corresponding moving average line will change accordingly. To find a right MA parameter of an investment, for example, a user can click one of the text boxes 813, 814 or 815. Suppose stock symbol Dia is selected from 812 and 815 is clicked, then he can give a search range for an moving average aimed to find out by entering a lower bound value of 101 in the example to text box 811 and upper bound value of 200 in this example to text box 808, and then drag and move graphic cue 810. Then curve line 800 and the text in 815 will change accordingly as the user is moving the graphic cue 810. If the user thinks the changed curve line 800 fits his needs at any point, he can simply stop dragging and moving 810. The number which is 150 in this case in the text box 815 is the right MA parameter the user is looking for. The user can change the MA curve lines for all investments on current screen by simply select item “All Charts” from combo box 812 and repeat the above operations. For example, if text box 815 is selected, when moving graphic cue 810, curve lines 800, 801, 802, 803, 804 and 805 will be changed accordingly with the moving graphic cue 810.

FIG. 9 demonstrates how to open orders, set warnings, conditions, and triggers in the system of present invention. The settings can be done for each one of the investment charts respectively. To set a price threshold, the user can drags the Price Setting Triangles such as 902, 912, 922 and 952 to a price level he desires and release the mouse button. Once the mouse button is released, a small panel like 900, 910, 920 or 950 will pop up to allow the user to open orders, set warnings, conditions, and triggers based on the price threshold set. If a user wants to change the threshold, he can do it by moving the Price Setting Triangle again or entering the desired price threshold directly into text box 903, 913, 923 or 953. The price threshold displayed on the chart is always the same as the price in the corresponding text box 903, 913, 923 or 953. Condition is set for triggers. To set a condition, the user can simply check the radio button 901 Set Condition and click on the OK button. Since the example shows that the price threshold is 111.62 and the current market price is lower than the threshold, the condition set is that the condition is met if the current market price reaches or is above the price threshold. In other words: “The condition is true if price >=111.62” as displayed on the panel 900. A warning is set by checking the radio button Set Warning like 911 and then clicking the OK button like 914. Since the example shows that the price threshold is 127.54 and the current market price is lower than the threshold, the warning set is to send a warning if the current market price reaches or is above the price threshold. In other words: “Send warning if price >=127.54” as displayed on the panel 910. An order is placed by checking the radio button Open Order like 921 and clicking the OK button like 924, then an order form like 930 will pop up next to the investment chart where this order form is invoked. The user can place orders on the order form. The orders may be any kind of orders, but not limited to, stock orders, option orders, future orders, spread orders or CFD (Contracts for Differences) orders. A trigger can be set by checking radio button Set Trigger like 951. Then the form like 900, 910 or 920 will expand to a panel looks like 950. A combo box like 956 for selection of conditions and operators, a button like 957 for adding conditions/operators and a text field like 958 for editing a trigger will show up. The user can select conditions and operators like AND, OR from 956 and click add button like 957. The system then adds the selected condition or operator and appropriate logic into the text field 958. If the user knows programming logic, he can type the logic of the trigger conditions into the text field 958 by himself directly. It should be noted that the small Price Setting Triangles symbol provided in this exemplary embodiment can be replaced by any other visual cue or object, including, but not limited to an arrow, a circle, or even simply the moving mouse cursor to achieve the same goal of setting the price level or threshold. Thus, other symbols can be used for this purpose as well.

It is very important to get real time data for any investment monitoring system. Existing systems normally get data from one source, i.e. from one server. The system of the present invention provides such a real time data receiving system. In addition, on-line trading brokers provide their customers real-time market and investment information, there are many web sites providing free real-time investment data, and there are growing needs from individual users for real-time multi-markets monitoring. The system of the present invention meets these needs by providing a multi-sources real-time data collection system.

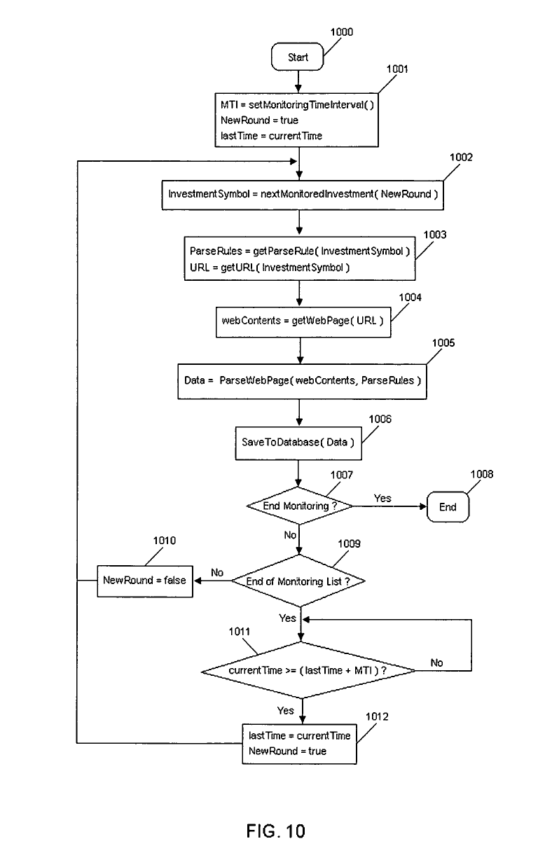

FIG. 10 is a flow chart that demonstrates the working mechanism of the multi-source real-time data collection system. After the data collection system is started at step 1000, it is initialized at step 1001. The system sets the monitoring time interval which is used to decide how frequently the data needs to be updated, assigns current time to variable lastTime and true to variable NewRound. At the next step 1002, the system will get an investment symbol from the list of monitored investments. If variable NewRound is true, it means that another round of update starts. The first investment symbol on the list will be returned by function nextMonitoredInvestment( ); if variable NewRound is false, it means that not all investments on the list have been updated at current round. It will return the next investment symbol on the list. After getting the investment symbol, the system will get the parse rules of the investment and the URLs where the investment information is published from database at step 1003. The URL stands for Uniform Resource Locator, or the global address of documents and other resources on the World Wide Web. After step 1003, the program will use the URL to locate the web page(s) and get those web contents at step 1004. And then it applies the parse rules against the web contents and gets the useful data at step 1005. At step 1006, the system will save the investment data fetched into the database. At step 1007, the program checks whether the user wants to end the monitoring. If yes, it goes to step 1008 and the monitoring and updating will be terminated; if no, it goes to step 1009 to check whether it has reached the end of the list of the monitored investments. If no, it will go back to step 1002 to continue updating another investment. Before it updates another investment, it sets NewRound to false to signal that the current round is not over yet at step 1010; if yes, it goes to step 1011 to check whether the set monitoring time interval is reached, if not, the program stalls here until the MTI is met. Then it goes back to step 1002 to start another round of updating. Before the new round starts, step 1012 re-initialize variables lastTime and NewRound.

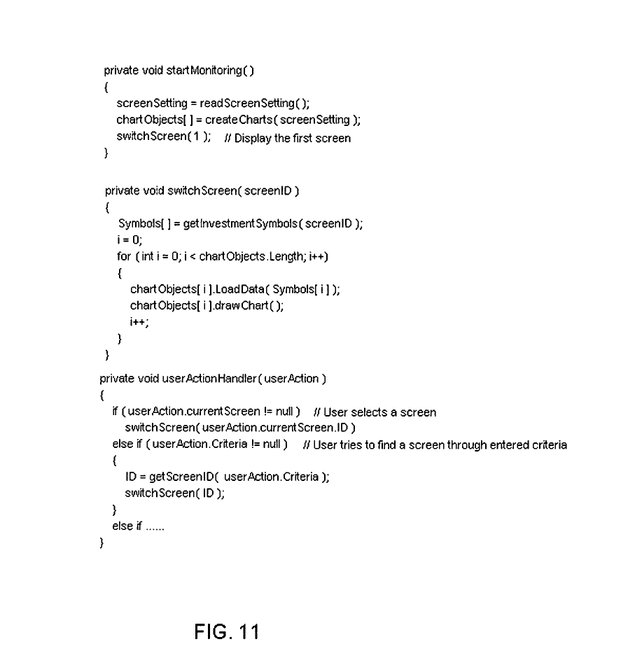

FIG. 11 is a piece of pseudo code that demonstrates the logic of the unlimited investments monitoring system. When a monitoring starts, the program of the system calls the startMonitoring( ) function. It creates several chart objects according to the configuration of the system. Each chart object may have all functions, from monitoring, analyzing, planning and recording to trading. The created chart objects are stored in the array variable chartObjects. By default, the system will display the first screen if it exists by calling the switchScreen( ) function. The switchScreen( ) function uses the screen ID to find the investment symbols on a screen associated with the screen ID and put them into array variable Symbols. It then updates all chart objects to display those investments. Function userActionHandler( ) is used to handle user's requests to change a screen. The user may change a screen by selecting a new screen, providing some criteria to find a screen or by other methods.

1. An investment chart based investment monitoring and trading method, said monitoring and trading method comprising the steps of:
using at least one computer;
using at least one database accessible by the computer(s), wherein the database comprises real historical information for a plurality of investments; and wherein the database optionally comprises settings for the investments;
using network connection(s) to a supply or supplies of real-time data, the real time data comprising real-time data relating to a plurality of investments;
generating one or more investment chart(s) for investment(s), wherein the investment chart is a daily investment chart with an intraday investment chart inside describing the same investment.

2. The method of claim 1, wherein the computer is a personal computer, a network server, or a hand-held communication device.

3. The method of claim 1, further comprising:
providing an Unlimited Investments Monitoring Method to monitor multi-investments at the same time, wherein, the Unlimited Investments Monitoring Method may comprise the steps of:
dividing and grouping multi-investments to be monitored into one or more computer screens, wherein each screen can display a limited number investment charts, but the number of screens is unlimited;
presenting one or more screens, each of which holds at least one investment chart for each investment being monitored;
providing a method for quickly switching between screens; and
using a search method to locate a screen, said search method comprising 1) using one or more of the following criteria: screen name, screen ID, investment symbol(s) defined for the screen and 2) displaying the screen.

4. The method of claim 1, further comprising:
providing a synchronized update of both of the daily investment chart and the intraday investment chart of the investment chart.

5. The method of claim 1, further comprising:
providing a synchronous multi-charts update method using global functions that allows multi-charts to be changed synchronously when one of the global functions is invoked.

6. The method of claim 1, further comprising a synchronous multi-charts update method controlled by global mode comprising the steps of:
providing a synchronous mode for user to select;
optionally providing global modes for users to select;
applying a function and a global mode if selected, to one or more investment charts on a screen and change them synchronously and correspondingly if the function is invoked on any one of the investment chart and the synchronous mode is selected.

7. The method of claim 1, further comprising a synchronous change of global mode method comprising the steps of:
providing global modes for users to select; and
applying selected global mode to multiple investment charts on a screen if a global mode is selected.

8. The method of claim 1, further comprising:
providing a Visualized Setting Method for a user to open orders and set warnings, conditions, and triggers directly on the investment charts, wherein the Visualized Setting Method comprises the steps of:
providing graphic cues on the investment chart;
moving the graphic cues to a appropriate price level on the investment chart by a user to set price or threshold desired; and
allowing the user to open orders and set warnings, conditions, and triggers after a desired price or threshold has been set.

9. The method of claim 1, further comprising:
providing a graphic bar indexed information search and presentation method comprising:
providing at least one investment chart with graphic bars, wherein the graphic bars may be invoked to cause execution of an action;
providing at least one information mode for the user to choose;
mapping the bars on the investment charts with dates or time periods;
taking actions to search information related to the selected information mode and date or time period the graphic bar represents after it is invoked by a user; and
presenting the found information to the user.

10. The method of claim 1, further comprising:
providing a technical indicator parameter search method comprising:
providing one or more investment chart(s);
allowing the value of technical indicator parameter(s) of the investment(s) to be controlled by a controller that can continuously change its/their value(s); and
allowing the technical indicator(s) displayed on the investment chart(s) to be changed simultaneously with the change value of the controller.

11. The method of claim 1, further comprising:
providing a multi-sources real-time data collection method comprising:
using one or more computers;
using network connection(s) to the data sources;
providing list of investment to be monitored;
providing parse rules and data source address for the monitored investments;
executing software on the computer(s) to get the contents pointed by the data source address; and
executing software on the computer(s) to parse the said contents by applying the said parse rules and get the useful data and optionally save them into the database.

12. The method of claim 1, further comprising:
providing a method to allow users to open order(s) directly on the investment chart.

13. The method of claim 1, further comprising:
providing a method to integrate real time market information into the investment chart.

14. An investment chart based investment monitoring and trading system, said system comprising:
one or more computers;
one or more databases accessible by the computer(s); wherein the databases have real historical information for a plurality of investments, and wherein the databases optionally comprise settings for the investments;
a connection or connections to a supply or supplies of real-time data, the real time data comprising real-time data relating to a plurality of investments;
software executing on the computer(s) to generate an interface displayed on one or more screens, and wherein the interface comprises one or more investment charts using the real historical data from the database and real-time data from its source, wherein the investment chart is a daily investment chart with an intraday investment inside.

15. The system of claim 14, wherein the computer is a personal computer, network server, or hand-held communication device.

16. The system of claim 14, further comprising an Unlimited Investments Monitoring System;
wherein, the Unlimited Investments Monitoring System 1) allows a user to divide and group multi-investments into one or more computer screens, wherein each screen can display a limited number investment charts, but the number of screens is unlimited; 2) present the screen which held at least one investment chart for each investment being monitored; 3) provide a system for quickly switching between screens and 4) use a search system to locate a screen and then quickly display the screen searched.

17. The system of claim 14, wherein the system synchronously updates both of the daily investment chart and the intraday investment chart of an investment chart.

18. The system of claim 14, further comprising a synchronous multi-charts update system using global functions; wherein the synchronous multi-charts update system using global functions 1) provides global functions to user to choose; and 2) applies a global function to one or more charts on a screen and changes them synchronously if one of these global functions is selected.

19. The system of claim 14, further comprising a synchronous multi-charts update system controlled by global mode,
wherein the synchronous multi-charts update system controlled by global mode 1) provides a synchronous mode for users to select; 2) optionally provides global modes for users to select; 3) applies selected global mode to one or more investment charts on a screen if a global mode is selected; and 4) applies a function to one or more investment charts on a screen and change them synchronously and correspondingly if any function in any one of the investment chart is invoked.

20. The system of claim 14, further comprising a synchronous change of global mode system,
wherein the synchronous change of global mode system 1) provides global modes for users to select; and 2) applies selected global mode to one or more investment charts on a screen if a global mode is selected.

21. The system of claim 14, further comprising a Visualized Setting System;
wherein the Visualized Setting System 1) provides graphic cues on the investment chart; 2) allows a user to move the graphic cues to a appropriate price level on the investment chart to set price or threshold desired; and 3) allows the user to open orders and set warnings, conditions and triggers after a desired price or threshold has been set.

22. The system of claim 14, further comprising a graphic bar indexed information search and presentation system,
wherein the graphic bar indexed information search and presentation system 1) provides at least one investment chart with graphic bars, wherein the graphics bars may be invoked to execute an action; 2) provides information modes for the user to choose; 3) maps the bars on the investment charts with dates or time periods; 4) takes actions to search information related to the selected information mode and date or time period the graphic bar represents after it is invoked by a user; and 5) presents the found information to the user.

23. The system of claim 14, further comprising a technical indicator parameter search system for investment(s),
wherein, the technical indicator parameter search system 1) provides one or more investment chart(s); 2) allows the value of the technical indicator parameter(s) of the investment(s) to be controlled by a controller that can continuously change the value of the parameter(s); and 3) allows the technical indicator(s) displayed on the investment chart(s) be changed simultaneously with the change value of the controller.

24. The system of claim 14, further comprising a multi-sources real-time data collection system,
wherein the multi-sources real-time data collection system 1) uses one or more computers; 2) uses network connection(s) to access the data sources; 3) provides a list of investments to be monitored; 4) provides parse rules and data source address for the monitored investments; 5) executes software on the said computer(s) to get the contents referenced by the data source address; 6) gets the useful date through executing software on the computer(s) to parse the said contents by applying the said parse rules; and 7) optionally saves the useful data into the database.

25. The system of claim 14, further comprising a system to allow users to open order(s) directly on the investment chart.

26. The system of claim 14, further comprising a system to integrate real time market information into the investment chart that allows users to get the information on the investment chart.
